(19) United States
(12) Patent Application Publication
(10) Pub. No.: US 2021/0234352 A1
(43) Pub. Date: Jul. 29, 2021

(54) CONDUCTOR STOPPER APPARATUS FOR BUSBAR

(71) Applicant: EAE ELEKTRIK ASANSOR ENDUSTRISI INSAAT SANAYI VE TICARET ANONIM SIRKETI, Istanbul (TR)

(72) Inventor: Bulent YENER, Istanbul (TR)

(21) Appl. No.: 16/765,377

(22) PCT Filed: May 17, 2019
(86) PCT No.: PCT/TR2019/050345

§ 371 Date: May 19, 2020

(51) Int. Cl. H02G 5/00; H02G 5/06

(52) U.S. Cl. CPC H02G 5/007; H02G 5/066

(57) ABSTRACT

A conductor stopper apparatus used in electrical distribution systems known as busbar, wherein the conductive bars contained within the busbar module body remain in place and do not slip outside the busbar module body in vertical applications.

### TECHNICAL FIELD

The invention relates to a conductor stopper apparatus for busbars used in energy distribution systems.

The invention relates, in particular, to the conductor stopper apparatus used in electrical distribution systems known as busbar, so that the conductive rods contained within the body remain in place and do not slide out of the busbar body in vertical applications.

### BACKGROUND OF THE INVENTION

In today's energy distribution systems, modular compact conductors called busbar are used. Each conductor called busbar is more preferred because it has structures with a high current carrying capacity.

Electrical distribution and transport systems known as busbar are modular. Each busbar module is attached to the end of the line according to the route of the electric line and forms the electric transport line. The modules are connected to each other by means of the so-called additional module.

The busbar add-on module connects the conductor rods in the busbar modules electrically and mechanically to each other and allows the line to continue.

When connecting the busbar modules via the busbar extension module, the conductor bars inside the busbar module are required to remain constant, not move out by moving freely. To achieve this, 3 different methods are used in the present art.

Common methods of these methods are the methods used inside the module body of the busbar.

The first of these methods is known as the slit forming method on the conducting rod. In this method, a slit opening is provided on the conductive rods carrying the electric current and the slipping of the conductive rods is prevented by a piece passing through this slit.

However, the use of this method causes the conductor to increase its resistance because of the reduction of the section, which increases the overall losses of the electricity distribution system.

Another method of conducting the stop is the method of protruding on the conductor rod. In the said method, the protruding rods are protruded by means of crushing or welding, and a piece passing through it is prevented from slipping of the conductive bars.

However, the use of this method leads to the deterioration of the current path and the resistance of the conductor. This increases the overall losses of the electricity distribution system.

The third method used is known as the form forming method on the conductive rod. In this method, it is ensured that the rods carrying the electric current are changed by changing the flatness of the rods and the slipping of the conductive rods is prevented by a piece which passes to the section where this change is made.

However, the use of this method causes the elongation and weight of the conductor to be increased as it causes elongation of the current carrying rods. This significantly increases the overall losses and costs of the electricity distribution system.

As it is seen, in all these methods, reaching a certain purpose brings with it another problem, the loss problem, and it is not possible to reveal a busbar structuring which works with 100% efficiency.

n the literature, the Korean patent application numbered KR20110061724 relates to a connection element is provided to increase the conductivity in order to increase the conductivity and improve the mounting properties. The insulation plates are vertically laminated. The conductive plates are arranged on a surface facing the insulating plates. To connect a bus channel, a bus is inserted between the conductive plates into both bus channels. A stopper allows the conductive plates to move closer together.

In the aforementioned application, in order to prevent the busbar conductors from slipping, the structure in which one housing is formed in one and the other in the same form as the protuberance is disclosed.

In the case of the Korean patent application KR20090056036, the present invention also provides a coupling kit comprising a stop for a bus channel to reduce the thickness of a coupling housing by forming a stop on a conductive plate. A joint housing is arranged at both ends of a connecting kit and a plurality of sealing plates are arranged between the common slots. The isolation plate comprises a concave portion and a protrusion and the projection is inserted into a hole of the conducting plate. The conductor plate is arranged on the concave portion of the insulation board and the stop is formed on the conductive plate. The stopper is made of the same material as the conductive plate and a plurality of spacers are disposed between the conductive plates.

In the said embodiment, the busbar system comprising a stop in the form of a protrusion formed on the conductive plate is described.

For the reasons mentioned above, there is a need for a new conductor stopper apparatus for busbar.

### PURPOSE OF THE INVENTION

The object of the invention is to provide a new conductor stopper apparatus for busbars which eliminate existing disadvantages.

Another object of the invention is to provide a structure in which stopping can be carried out without the need for lengthening the lengths of the conductive bars, thereby causing no increase in the resistance and weight of the conductor.

Another object of the invention is to provide a structure where stopping can be carried out without reducing the cross-sections of the conductive bars, thus causing no increase in the resistance of the conductor.

A further object of the invention is to provide a structure in which the stopping of the conductive bars without disrupting the current paths can be carried out, thereby causing an increase in the resistance and weight of the conductor.

It is a further object of the invention to provide a structure which ensures that the busbar conductors are stationary, especially in vertical assemblies.

Another object of the invention is to provide a structure that minimizes losses that may occur in the conductive bars.

Another object of the invention is to provide a structure in which conductor stopping can be carried out without any deformation and operation on the conductors.

Another object of the invention is to provide a structure in which energy loss losses are minimized and costs are minimized.

### EXPLANATION OF FIGURES

FIG. 1 side cross-sectional view of the conductor stopper apparatus of the invention mounted on the busbar module body

FIG. 2 is a perspective view of the conductor stopper according to the invention mounted on the busbar module body

FIG. 3 is a perspective view of the conductor stopper according to the invention disassembled on the busbar module and the additional connection module

### REFERENCE NUMBERS

1. Busbar Module
1.1 Conductive Bars
1.2 Busbar Module Body
2. Conductor Stopper Apparatus
2.1 Stopping Tip
2.2 Conductor Guide Holes
2.3 Conductor Slot
3. Additional Connection Module

### DETAILED DESCRIPTION OF THE INVENTION

In this detailed description, innovation according to the invention is explained by examples which will not have any limiting effect on a better understanding of the subject.

The invention is a stopper apparatus used to keep the conductive bars (1.1) located within the busbar module body (1.2) in the electrical distribution systems known as busbar, and to not move outside the busbar module body (1.2) in vertical applications; characterized in that conductor stopper apparatus (2), which is mounted on two open ends of said busbar module body (1.2), allowing for easy mounting by preventing gliding of said busbar module (1.2) without making any physical changes in said conductive bars (1.1).

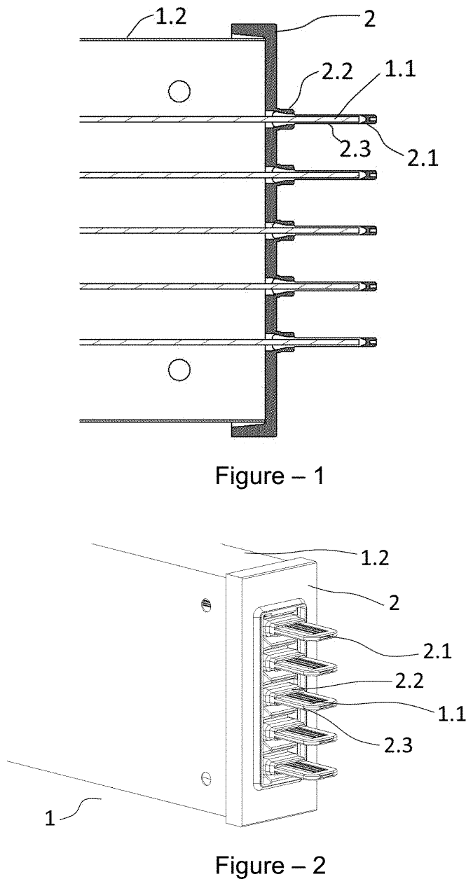

FIG. 1 shows a side cross-sectional view of the conductor stopper apparatus of the invention mounted on the busbar module body.

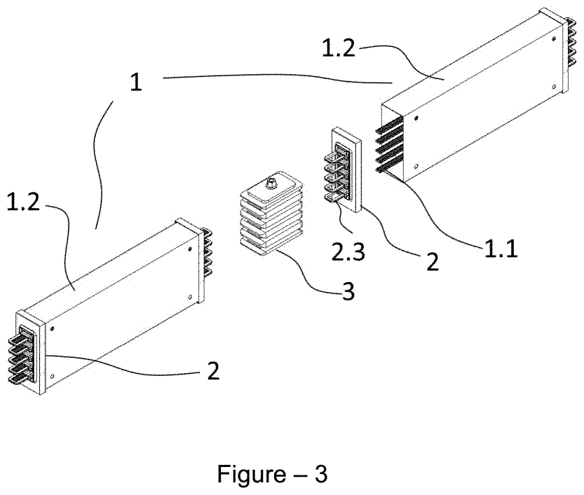

FIG. 2 shows a perspective view of the conductor stopper according to the invention mounted on the busbar module body.

FIG. 3 shows a perspective view of the conductor stopper according to the invention disassembled on the busbar module and the additional connection module.

The stopping apparatus according the invention consists of main parts that; the busbar module (1) used in the electrical distribution systems known as busbar, the conductive bars (1.1), which are the part of the busbar module (1) providing the energy transmission, the busbar module body (1.2) which protects said conductive bars (1.1) from external factors, a conductor stopper apparatus (2), which is mounted on two open ends of said busbar module body (1.2), allowing for easy assembly by preventing gliding of said busbar module body (1.2) without making any physical changes in said conductive bars (1.1), the stopping tip (2.1) positioned at the extreme end of said conductor stopper apparatus (2), the portion in which said conductive bars (1.1) are stopped, conductor guide holes (2.2) positioned on said conductor stopper apparatus (2), allowing said conductive bars (1.1) to easily enter into said conductor stopper apparatus (2), a conductor slot (2.3) with a conductive feature, wherein said conductive bars (1.1) are positioned in the conductor stopper apparatus (2) and which comprise the portion from the conductor guide holes (2.2) to the stopping tip (2.1).

Electrical distribution and transport systems known as busbar are modular. Each busbar module (1) is attached to the end of the line according to the route of the electric line and forms the electric transport line.

Said busbar modules (1) are connected to each other by means of an additional connecting module (3). Said additional connecting module (3) connects the conductive bars (1.1) located in the busbar modules (1) electrically and mechanically to each other and ensures the continuity of the line.

When connecting the busbar modules (1) via the additional connection module (3), the conductor rods (1.1) inside the busbar module (1) are required to remain stable, do not move out and move freely.

In order to prevent the said conductive bars (1.1) from shifting outward, a new method is used instead of the former methods. Conductor stopper apparatus (2) parts are fitted as stoppers to the open ends of the busbar module body (1.2).

By means of said conductor stopper apparatus (2), the conductive bars (1.1) cannot move out of the busbar module body (1.2).

1. A stopper apparatus used to keep conductive bars located within the a busbar module body in an electrical distribution systems known as busbar, and to not move outside the busbar module body in vertical applications, characterized in that it comprises a conductor stopper apparatus, which is mounted on two open ends of said busbar module body, allowing for easy mounting by preventing gliding of said busbar module without making any physical changes in said conductive bars.

2. A stopper apparatus according to claim 1, comprising a stopping tip positioned at the extreme end of said conductor stopper apparatus, the portion in which said conductive bars are stopped.

3. A stopper apparatus according to claim 1, comprising conductor guide holes positioned on said conductor stopper apparatus, allowing said conductive bars to easily enter into said conductor stopper apparatus.

4. A stopper apparatus according to claim 1, comprising a conductor slot with a conductive feature, wherein said conductive bars are positioned in the conductor stopper apparatus and which comprise the portion from the conductor guide holes to the stopping tip.
